(19) United States
(12) Patent Application Publication
(10) Pub. No.: US 2006/0061681 A1
(43) Pub. Date: Mar. 23, 2006

(54) Visual presentation apparatus having illuminating system

(75) Inventors: Chung-Ting Wei, Jhubei City (TW); Tsun-Ching Wang, Jhubei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Lumens Digital Optics Inc., Jhubei City (TW)

(21) Appl. No.: 11/005,840

(22) Filed: Dec. 7, 2004

(30) Foreign Application Priority Data
Sep. 22, 2004 (TW) 093215158

(51) Int. Cl. H04N 5/222

(52) U.S. Cl. 348/370

(57) ABSTRACT

A visual presentation apparatus with an improved illuminating system is provided. The visual presentation apparatus includes a base, and the base includes a camera system and the illuminating system. The illuminating system includes a light-emitting element for providing a light source of the illuminating system, a tunneling element for collecting a light emitted from the light-emitting element, and a lens for controlling a focus and a projecting area of the light. The light passes through the tunneling element is in an even distribution.

### FIELD OF THE INVENTION

The present invention relates to a visual presentation apparatus, and more particularly to a visual presentation apparatus having an illuminating system.

### BACKGROUND OF THE INVENTION

Please refer to FIG. 1, which schematically illustrates a visual presentation apparatus and its application according to the prior art. In order to present the object 2 on the monitor 3, the user 20 generally employs a camera to pick up images of the object 2 and transform the images into electronic signals, and further the images are presented on the monitor 3 thereby. The monitor 3 can be a self-emitted monitor, such as a liquid crystal display, a plasma TV, and a light emitting diode arrays, etc. The monitor 3 can be also a screen for receiving a projection of the projector 18. The conventional visual presentation apparatus 1 is located on the ceiling 4 and usually includes the camera system 12 to pick up the image of the object 2. As to the light for illuminating the object 2, it comes from an external environment where the user 20 operates the camera system 12. In some conditions, however, the camera system 12 on the ceiling 4 is too far to provide the object 2 with a well illumination. Hence the light reflected by the object is much fewer. Even though the problem can be overcome by using a projecting light 42 in the external environment during the operation, the projecting light 42 and the visual presentation apparatus 1 are still different parts and the projecting light 42 is not specifically designed for the visual presentation apparatus 1. Therefore, the projecting light 42 is not suitable enough for the visual presentation apparatus 1 to provide an efficient operation.

As shown in FIG. 1, in order to overcome the above problems, the visual presentation apparatus 1 is further designed and popularized. The visual presentation apparatus 1 is equipped with the illuminating light 14 in the case 10, and the illuminating light 14 is a simple incandescent lamp. In addition, the visual presentation apparatus 1 can be further equipped with another projecting light 16. Usually, the projecting light 16 is a halogen light with a reflection collector so as to gather the light in a more condensed region. Therefore, the projecting light 16 has a higher illumination efficiency than that of the illuminating light 14. However, the central area of the illumination region provided by the projecting light 16 is still too bright, and the peripheral area is still short of sufficient light and vague. This defect result from the light diffusion. Besides, it is difficult to adjust the size and the shape of the projecting area provided thereby.

Moreover, a lens (not shown) could be set in front of the projecting light 16 so as to focus the light. The combination of the lens provides a better illumination than the case that only the projecting light 16 is used. However, even though the light is more focused, a uniform distribution of the illumination is still not achieved thereby. In other words, the lens in front of the projecting light 16 is applied to focus the light, but cannot provide the light therefrom an even distribution. Hence, the light projected on the object 2 is still in an uneven distribution. Therefore, in the field of visual presentation apparatus, it is necessary to develop an improved illuminating system for providing the light of a more uniform distribution.

### SUMMARY OF THE INVENTION

The present invention provides a visual presentation apparatus. The visual presentation apparatus includes a base, wherein the base includes a camera system, and an illuminating system including a light-emitting element for providing a light source of the illuminating system, a tunneling element for collecting a light emitted from the light-emitting element, and a lens for controlling a focus and a projecting area of the light, wherein the light is emitted from the light-emitting element and passes through the tunneling element and the lens.

Preferably, the lens has a variable focal length.

Preferably, the illuminating system includes a light-deflecting element for changing a direction of the light passing through the lens.

Preferably, the light-deflecting element has a reflective plate and an adjusting component for controlling the reflecting angle of the light.

Preferably, the lens has a shift component.

Preferably, the shift component is used for offsetting and tilting the light passing through the tunneling element.

Preferably, the illuminating system includes a mask between the lens and the tunneling element for controlling a cross-section shape of the light passing through the tunneling element.

In accordance with another aspect of the present invention, the visual presentation apparatus includes a base, wherein the base includes a camera system, and an illuminating system including a light-emitting element for proving a light source of the illuminating system, a tunneling element having a first end and a second end, wherein the first end is located next to the light-emitting element for limiting the light emitted from the light-emitting element within the tunneling element so that the light passes along the tunneling element to leave from the second end, and a light-deflecting element located next to the second end for changing a direction of the light, which leaves out from the second end.

Preferably, the illuminating system further includes a mask for controlling a cross-section shape of the light emitted from the second end.

The foregoing and other features and advantages of the present invention will be more clearly understood through the following descriptions with reference to the drawings, in which:

### BRIEF DESCRIPTION OF THE DRAWINGS

FIG. 1 is a schematic view showing an visual presentation apparatus and its application according to the prior art;

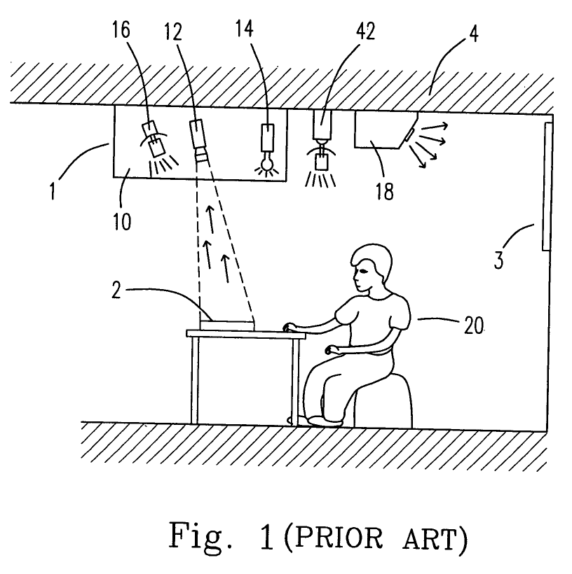

FIG. 2 is a schematic view showing the illuminating system according to a preferred embodiment of the present invention; and

FIG. 3 is a planar schematic view showing the visual presentation apparatus according to the preferred embodiment of the present invention;

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

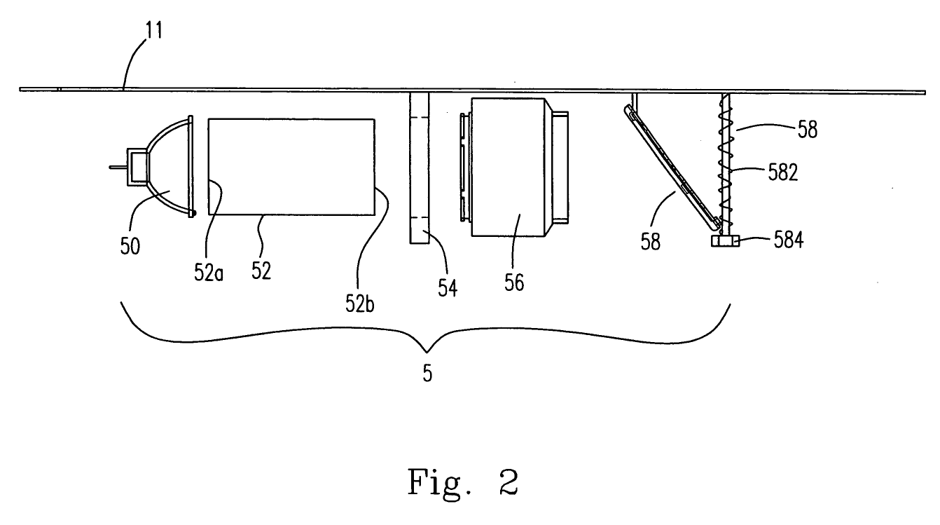

Please refer to FIG. 2, which is a schematic view showing the illuminating system according to a preferred embodiment of the present invention. The illuminating system 5 is configured on the base 11. The illuminating system 5 includes the light-emitting element 50. The light-emitting element 50 is usually a halogen lamp with a collector to collect and guide the light to a specific direction, which is a propagation direction of the light emitted from the light-emitting element 50. Along the direction, the tunneling element 52 is located next to the light-emitting element 50 so that the light-emitting element 50 faces the first end 52a of the tunneling element 52.

The tunneling element 52 is applied to limit the light propagation. The inner surface of the tunneling element 52 is processed via a surface treatment, such as mirror treating, metal electroplating, and polishing, so as to provide a good reflection for the light. Also, the tunneling element 52 could be directly formed by mirrors, metal plates, or optical fibers. When the light is propagates in the tunneling element 52, the light would be repeatedly reflected and limited to a certain range. Generally, the range is the cross-section area of the tunneling element 52. After passing through the tunneling element 52, the light is well distributed thereby in the illuminating area, and the light intensity for the peripheral area is almost equal to that for the central area. Therefore, the unevenness of the light distribution between the peripheral area and the central area is prevented, and the problem that the light diffuses to the environment would be overcome. In addition, the illuminating range of the illuminating system 5 provided by the present invention is definite, which is superior to the conventional one.

According to the prior art, it is necessary for the conventional visual presentation apparatus to enlarge the illuminating range to provide the object with a sufficient light. When the illuminating range is enlarged, the user would be interfered by the edge light and the light intensity within the certain area would be reduced. Therefore, a readjustment for the light sensitivity of the whole camera system is further needed. Compared to the present invention, the problem is overcome. Since the light passes through the tunneling element 52, the present invention provides the light in a more uniform distribution.

As shown in FIG. 2. If a certain shape of the illuminating range is needed, a mask 54 can be set next to the second end 52b of the tunneling element 52 for providing a certain shape of the illuminating range. Moreover, if the adjustment of the illuminating range is needed, the cross-section of the second end 52b of the tunneling element 52 can be directly changed or the lens 56 can be employed to adjust the illuminating range. The lens is used for the light to project on the object. Since the light emitted from the second end 52b of the tunneling element 52 is in an even distribution, the light projected on the object 2 is also in an even distribution.

In order to keep the visual presentation apparatus more compact, the illuminating system 5 is put in parallel to the ceiling. The tunneling element 52 of the illumination system 5 is hence parallel to the ceiling, and the light emitted from the tunneling element 52 is also parallel to the ceiling. In order to guide the light to the object 2, the light-deflecting element 58 is put in front of the tunneling element 52 or in front of the lens 56. Generally, the light-deflecting element 58 is a mirror. The light-deflecting element 58 is located on the adjusting shaft 580 and is tightly propped by the spring 582 and the adjusting component 584. The adjusting component 584 is used for adjusting the light-deflecting element 58 so as to control the reflecting angle of the light.

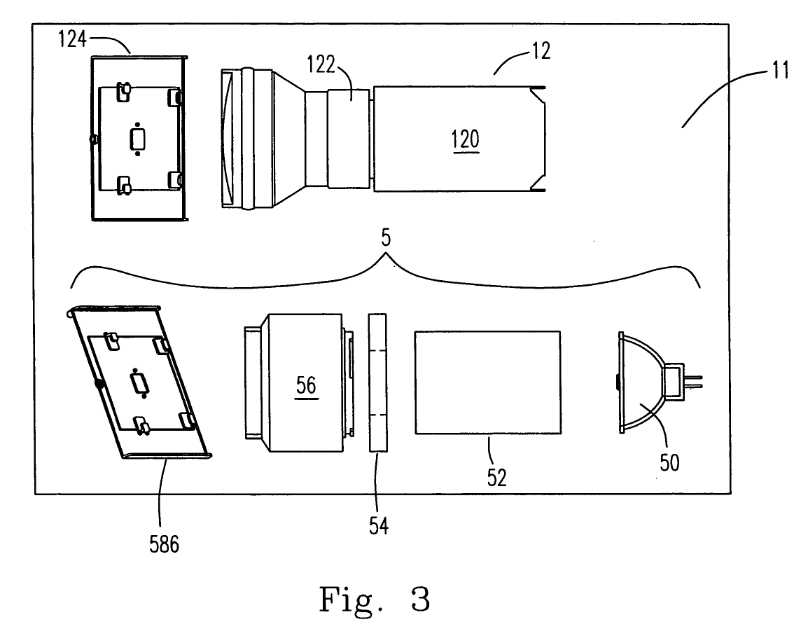

Please refer to FIG. 3, which is a planar schematic view showing the visual presentation apparatus according to the preferred embodiment of the present invention. The camera system 12 is next to the illuminating system 5. The camera system 12 includes the video camera 120 equipped with the camera lens 122, and also includes the reflective frame 124. A reflective mirror (not shown) is configured on the reflective frame 124 so as to reflect an image of the object to the camera lens 122. Since the video camera 120 is not directly arranged on the object, there may exist problems on the perspective and the depth of field. These problems can be overcome by using the camera lens having a shift component (not shown). The shift component is used for offsetting and tilting an image produced by said video camera. As to the illuminating system 5, the light-emitting element 50, the light-tunneling element 52, the mask 54, and the lens 56 has shown in FIG. 2 and been described above. In addition, the light-deflecting frame 586 is used to support the light-deflecting element 58, and needs to be tilted with a certain angle, so that the photographing range could conform to the illuminating range.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A visual presentation apparatus, comprising a base, wherein said base comprises:
a camera system; and
an illuminating system comprising:
a light-emitting element for providing a light source of said illuminating system;
a tunneling element for collecting a light emitted from said light-emitting element; and
a lens for controlling a focus and a projecting area of said light;
wherein said light is emitted from said light-emitting element and passes through said tunneling element and said lens.

2. The apparatus according to claim 1, wherein said lens has a variable focal length.

3. The apparatus according to claim 1, further comprising a light-deflecting element for changing a direction of said light passing through said lens.

4. The apparatus according to claim 3, wherein said light-deflecting element has a reflective plate and an adjusting component for controlling a reflecting angle of said light.

5. The apparatus according to claim 1, wherein said lens has shift component.

6. The apparatus according to claim 5, wherein said shift component is used for offsetting and tilting a projecting area of said light.

7. The apparatus according to claim 1, further comprising a mask between said lens and said tunneling element for controlling a cross-section shape of said light passing through said tunneling element.

8. A visual presentation apparatus, comprising a base, wherein said base comprises:
a camera system; and
an illuminating system comprising:
a light-emitting element for proving a light source of said illuminating system;
a tunneling element having a first end and a second end, wherein said first end is located next to said light-emitting element for limiting said light emitted from said light-emitting element within said tunneling element so that said light passes along said tunneling element to leave from said second end; and
a light-deflecting element located next to said second end for changing a direction of said light, which leaves out from said second end.

9. The apparatus according to claim 8, further comprising a mask for controlling a cross-section shape of said light emitted from said second end.
